(19) United States
(12) Patent Application Publication
(10) Pub. No.: US 2024/0381840 A1
(43) Pub. Date: Nov. 21, 2024

(54) LIGHTWEIGHT LIVESTOCK EAR TAG DEVICE HOUSING

(71) Applicant: JVD, INC., Scotts Valley, CA (US)

(72) Inventors: Michael L. VANDIERENDONCK, Scotts Valley, CA (US); Ronald POWERS, Ben Lomond, CA (US)

(21) Appl. No.: 18/640,330

(22) Filed: Apr. 19, 2024

Related U.S. Application Data
(60) Provisional application No. 63/467,802, filed on May 19, 2023.

(51) Int. Cl. A01K 11/00; A01K 29/00; G09F 3/02

(52) U.S. Cl. CPC A01K 11/008; A01K 11/004; A01K 29/005; G09F 3/02

(57) ABSTRACT

A sensor tag includes a sensor unit located within a unit pouch and at least in part encapsulated by a protective barrier. The protective barrier is made of a polymeric material. The sensor tag weighing a total of no more than about 34.5 grams. The sensor tag may be a positioning tag, a gas composition tag, an accelerometer tag, an environmental tag, or a signal relay tag. A method for using a sensor tag includes detecting that a detrimental event to an animal has occurred during a period. The sensor tag is configured with a geo-locating sensor for detecting geo-location and producing geo-location data. The method includes obtaining the detected geo-location data for the period for the animal impacted by the detrimental event from the associated sensor tag using a signal connection. The method includes determining the location where the detrimental event occurred using the detected geo-location data.

### CROSS-REFERENCE TO RELATED APPLICATIONS

This application claims benefit of U.S. Provisional Patent Application No. 63/467,802, filed May 19, 2023, which is herein incorporated by reference in its entirety.

### BACKGROUND

The ear of an animal, especially on cattle, has many benefits for placement of animal management devices. Animal management devices include activity monitors, location monitoring and tracking devices, such as GPS devices, and wireless communication devices. Other uses of such devices may be envisioned, such as long-term temperature or moisture monitoring.

The ear of an animal is beneficial in that animal ears are generally more sensitive than other extremities and are therefore less prone to wear and tear as an animal proceeds with everyday activities. Neck collars are generally not as suitable as animals may graze in dense brush, where the collar may be caught or stick to plant branches, rocks, or other obstacles. If the collar is caught, then the animal may injure itself or even may die as a result of being trapped.

Current animal ear tags and ear tag retention devices have a limited maximum weight allowance. The maximum weight allowance is the amount of weight that may be held by the animal ear so as to avoid the ear tag creeping down an ear. If the weight of the ear tag exceeds this threshold weight, the ear tag will eventually creep down the ear of an animal and drop out of the bottom of the ear. Tag creep is known to cause irritation and injury to the animal, including scaring and infection.

### SUMMARY

A sensor tag includes a sensor unit located within a unit pouch and at least in part encapsulated by a protective barrier. The protective barrier is made of a polymeric material. The sensor tag weighing a total of no more than about 34.5 grams (about 1.22 ounces). In some instances, the sensor tag is positioning tag and the sensor unit is a positioning unit. In some instances, the sensor tag is a gas composition tag and the sensor unit is a gas composition unit. In some instances, the sensor tag is an accelerometer tag and the sensor unit is an accelerometer unit. In some instances, the sensor tag is an environmental tag and the sensor unit is an environmental unit. In some instances, the sensor tag is an environmental tag and the sensor unit is an environmental unit. The sensor tag is a signal relay tag and the sensor unit is a signal relay unit.

A method for using a sensor tag includes detecting that a detrimental event to an animal has occurred during a period. The sensor tag is configured with a geo-locating sensor for detecting geo-location and producing geo-location data and is coupled to the animal. The method includes obtaining the detected geo-location data for the period for the animal impacted by the detrimental event from the associated sensor tag using a signal connection. The method also includes determining the location where the detrimental event occurred using the detected geo-location data. The method may also include determining the location of the animal impacted by the detrimental event for a period between about the occurrence of the detrimental event and the detection of the detrimental event using the detected geo-location data. The method may also include applying a mitigation to the determined location where the detrimental event occurred, where the mitigation is suitable to prevent future occurrence of the detrimental event. The method may also include applying the mitigation to the determined location where the animal impacted by the detrimental event for a period between about the occurrence of the detrimental event and the detection of the detrimental event.

### BRIEF DESCRIPTION OF THE DRAWINGS

So that the manner in which the recited features of the present disclosure may be understood in detail, a more particular description of the disclosure may be had by reference to one or more embodiments, some of which are illustrated in the appended drawings. It is to be noted, however, that the appended drawings illustrate only one or more of the several embodiments; therefore, the one or more embodiments provided in the Drawings are not to be considered limiting of the broadest interpretation of the detailed scope. Other effective embodiments as may be described in the Detailed Description may be considered part of the envisioned detailed scope.

FIGS. 1A-B are schematic drawings of a front and side views, respectively, representing a positioning tag, which is an embodiment of a sensor tag, according to one or more embodiments. FIGS. 1C-D are schematic drawings of a front and side views, respectively, representing a gas composition tag, which is an embodiment of a sensor tag, according to one or more embodiments. FIGS. 1E-F are schematic drawings of a front and side views, respectively, representing a second gas composition tag, which is an embodiment of a sensor tag, according to one or more embodiments.

FIGS. 2A-B are schematic drawings of a front and side views, respectively, representing a positioning unit. FIGS. 2C-E are schematic drawings of a front, side, and back views, respectively, representing a gas composition unit.

FIGS. 3A-B are schematic drawings representing both a front and a back portion, respectively, of a protective barrier, according to one or more embodiments. FIGS. 3C-D are schematic drawings of a front and side views, respectively, representing a protective barrier for a positioning unit comprising the front and back portions provided previously in FIGS. 3A-B, according to one or more embodiments. FIGS. 3E-F are schematic drawings of a front and side view, respectively, representing a protective barrier formed around a portion of a positioning unit, according to one or more embodiments. FIGS. 3G-I are schematic drawings of a front, side, and back views, respectively, representing a protective barrier formed around a portion of a gas composition unit, according to one or more embodiments.

FIGS. 4A-D are a series of schematic drawings representing several portions of a method for fabricating a sensor tag, according to one or more embodiments.

In this disclosure, the terms “top”, “bottom”, “side”, “above”, “below”, “up”, “down”, “upward”, “downward”, “horizontal”, “vertical”, and the like do not refer to absolute directions. Instead, these terms refer to directions relative to a nonspecific plane of reference. This non-specific plane of reference may be vertical, horizontal, or other angular orientation.

To facilitate understanding and better appreciation for the described scope, in some instances either identical or similar reference numerals have been used (where possible) to designate identical or similar elements, respectively, that are common in the various Drawings. One of skill in the art may appreciate that elements and features of one embodiment may be beneficially incorporated in one or more other embodiments without further recitation.

### DETAILED DESCRIPTION

In the following disclosure, reference may be made to one or more embodiments, which may be combined with other embodiments. However, one of skill in the art appreciates that the disclosure is not limited to any specifically described embodiment. Rather, any combination of features and elements, whether related to different embodiments or not, is contemplated to implement and practice the one or more embodiments provided by the disclosure. Furthermore, although the one or more embodiments presented in the disclosure may achieve certain advantages over other possible solutions, the prior art (if existing), and combinations thereof, whether or not a particular advantage is achieved by a given embodiment is not limited by this disclosure. The aspects, features, embodiments, and advantages provided are merely illustrative, and do not limit the scope of the disclosure. The aspects, features, embodiments, and advantages provided are not considered elements or limitations of the appended claims except where explicitly recited in one or more of the Claims. Likewise, one of skill in the art should not construe a reference to “the disclosure” as a generalization of any disclosed subject matter.

The present disclosure relates to various embodiment configurations and methods of manufacture of a sensor tag for attachment to an animate or inanimate object. In one or more embodiments, which may be combined with other embodiments, the sensor tag is configured as a positioning tag. In the instance of a positioning tag, the positioning tag is configured to track passively, provide actively, or both, the position of the object unto which the positioning tag is affixed, such as a package, a vehicle, or a domesticated or non-domesticated animal. In one or more embodiments, which may be combined with other embodiments, the sensor tag is configured as a gas composition tag. In the instance of a positioning tag, the gas composition tag is configured to detect and monitor one or more components in the atmosphere around where the gas composition tag is located.

For the purposes of this application, any sensor tags, including the positioning and gas composition tags, may be appreciated as described in use with a domesticated animal; however, one of ordinary skill in the art appreciates that both inanimate and animate objects of various sorts may have one or more embodiments, which may be combined with other embodiments, of a sensor tag affixed thereto.

A unit pouch, which is a part of the sensor tag configuration, may be fabricated of one or more materials that is significantly resistant to abrasion, tearing, and liquids, such as water. Abrasion resistance may be better appreciated as the ability to withstand the effects of wear. The unit pouch may comprise of one or more pieces of material that may be mechanically or chemically coupled or connected together to form the unit pouch. In one or more embodiments, which may be combined with other embodiments, the unit pouch is formed from a unitary material, that there are no seams or junctions to make to couple or connect two or more surfaces.

In one or more embodiments, which may be combined with other embodiments, the material comprising the unit pouch is configured to permit electromagnetic (EM) signals, such as radio frequency (RF), cellular, and satellite-based communications, to traverse through the material with de minimus absorption. In terms of this application, de minimus absorption of EM signals means that at least about 99.5% of the strength of the EM signal passes through the material, such as 99.5%, 99.6%, 99.7%, 99.8%, 99.9%, 99.95%, 99.99%, and about 100%. The edging of two or more surfaces of pieces of the material. The unit pouch defines an interior void into which a sensor unit, such as a positioning unit or a gas composition unit, is located, secured, and maintained.

In one or more embodiments, which may be combined with other embodiments, the sensor unit is a positioning unit. In one or more embodiments, which may be combined with other embodiments, the sensor unit is a gas composition unit. In one or more embodiments, which may be combined with other embodiments, the sensor unit is an accelerometer. In one or more embodiments, which may be combined with other embodiments, the sensor unit is an environmental sensor. For example, an environmental sensor may be a sensor that is configured to detect the relative humidity, wind direction, wind velocity, barometric pressure, and combinations thereof, of the air around the sensor.

A protective barrier, which is a part of the sensor tag configuration, may be coupled to or connected to the sensor unit. In one or more embodiments, which may be combined with other embodiments, the material comprising the protective barrier is configured to permit electromagnetic (EM) signals, such as RF, cellular, and satellite-based communications, to traverse through the material with de minimus absorption. The protective barrier may provide protection against physical damage, resistance to moisture in the air and mitigate liquid water exposure, and prevent thermal shock by acting as an insulator against rapid temperature change to the sensor unit. In one or more embodiments, which may be combined with other embodiments, the protective barrier is comprised of a carbon-based polymeric material. In one or more embodiments, which may be combined with other embodiments, the protective barrier is comprised of a silicon-based polymeric material. In one or more embodiments, which may be combined with other embodiments, the protective barrier is comprised of a hydrophobic polymer.

In one or more embodiments, which may be combined with other embodiments, the protective barrier is comprised of a foamed material. In such instances, the foamed material may have little or no permeability. As well, the foamed material may have a significant overall pore volume fraction. Integrating such a foamed architecture into the protective layer may contribute to water resistance, preventing prevent normal moisture exposure as well as resisting accumulation of liquid water in the sensor tag by not permitting retention of liquid water in the non-permeable voids, such as when the foam is potentially immersed in liquid water. A foam material may also contribute to the overall lightness of the sensor tag because of the vapor-filled voids.

In one or more embodiments, which may be combined with other embodiments, the protective barrier is comprised of an elastic material. A protective barrier with elastic properties may provide significant protection by absorbing and retransmitting physical shock and prevent the unit sensor from absorbing the force of impact, such as against other inanimate or animate objects.

The sensor tag weighs in total of no more than about 34.5 grams (about 1.22 ounces). In one or more embodiments, which may be combined with other embodiments, the sensor tag weighs in a range of from about greater than 0 to 34.5 grams, such as in a range of from about 5 to 34.5 grams such as in a range of from about 10 to 34.5 grams, such as in a range of from about 15 to 34.5 grams, such as in a range of from about 20 to 34.5 grams, such as in a range of from about 25 to 34.5 grams, such as in a range of from about 30 to 34.5 grams, such as about 30 grams, such as about 30.5 grams, such as about 31.0 grams, such as about 31.5 grams, such as about 32.0 grams, such as about 32.5 grams, such as about 33.0 grams, such as about 33.5 grams, such as about 34.0 grams, and such as about 34.5 grams.

Therefore, what is needed is one or more sensor tags that enables one or more sensor units, such as a positioning unit and a gas composition unit, to each be retained securely, such as part of an ear tag for a domesticated animal, not having a weight greater than 34.5 grams so as to avoid creep down of the sensor tag, causing irritation, inflammation, or damage to the ear of the animal, and potentially loss of the sensor tag.

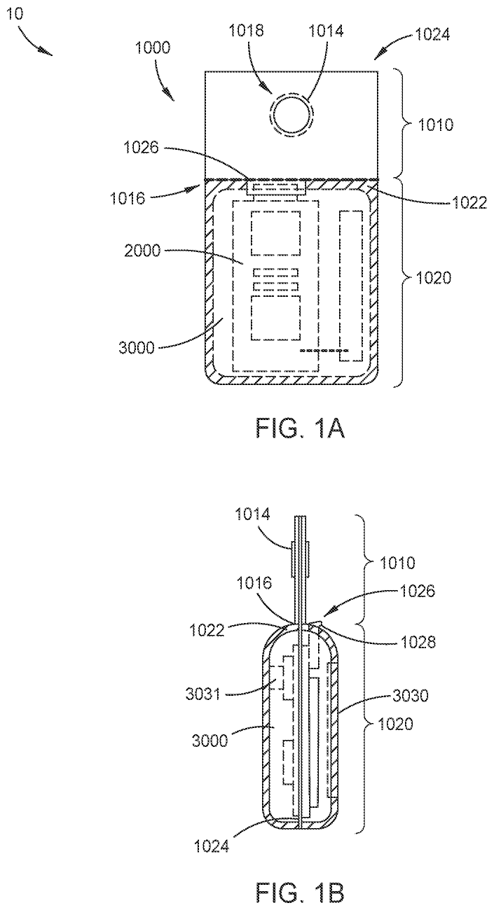

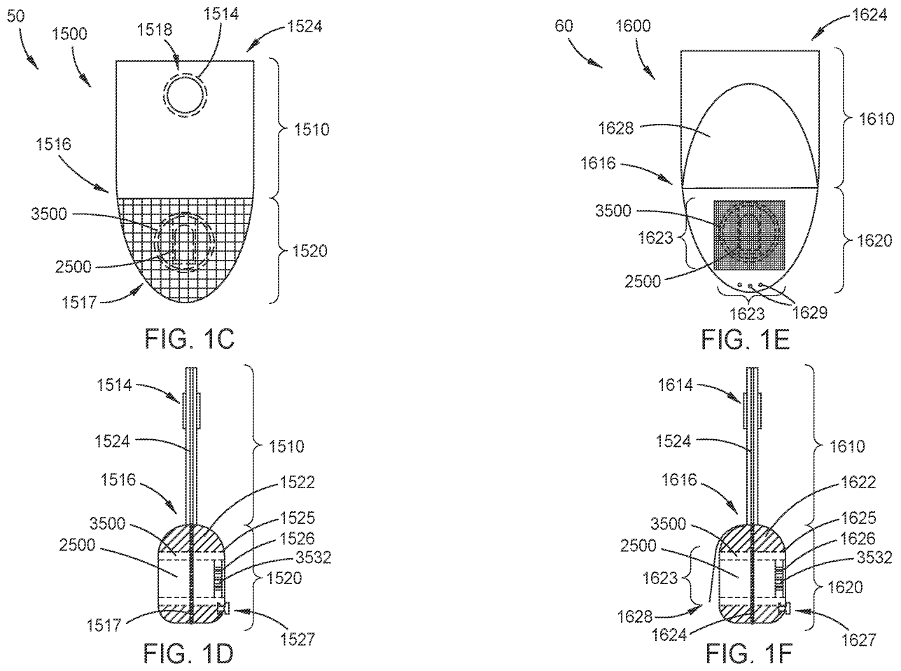

FIGS. 1A-B are schematic drawings of a front and side views, respectively, representing a positioning tag, which is an embodiment of a sensor tag. Positioning tag 10 is shown with a front view in the upper image and with a side view in the lower image. Reference to position tag 10 may be made to one or both views simultaneously. Position tag 10 is shown having three components related to one another, such as through containing, coupling, or connection: a positioning unit pouch 1000 (“unit pouch”), a positioning unit 2000, and a protective barrier 3000. In FIGS. 1A-B, positioning unit 2000 is shown contained within protective barrier 3000, and both protective barrier 3000 and positioning unit 2000 is located within a portion of the unit pouch 1000 (both are shown in relief).

As shown in FIGS. 1A-B, the unit pouch 1000 is configured as the exterior layer for the positioning tag 10. The unit pouch acts as a boundary that defines an interior void (not shown), which as seen in FIGS. 1A-B contains within and completely envelopes both the positioning unit 2000 and the protective barrier 3000 (both shown in relief). In one or more embodiments, which may be combined with other embodiments, the unit pouch comprises a single piece of material. That is, one piece of fabric or film is utilized—often folded over upon itself—and then coupled such that a unit pouch with an interior void forms. In one or more embodiments, the unit pouch comprises more than one piece of material.

Although not shown in FIGS. 1A-B, in one or more embodiments, which may be combined with other embodiments, the unit pouch is comprised, consists, or consists essentially of a plurality of external layers. For example, in FIGS. 1A-B, a single layer is shown; however, in one or more instances two or more exterior layers may be utilized, where one layer acts as an internal-most external layer and another layer acts as an external-most external layer. In one or more embodiments, which may be combined with other embodiments, when the unit pouch comprises a plurality of layers the external-most layer is comprised of a different material than the internal-most layer. In one or more embodiments, which may be combined with other embodiments, where there is a plurality of layers, when the unit pouch comprises a plurality of layers the external-most layer is comprised of a different material than the internal-most layer. For example, a unit pouch may comprise two separate layers of a woven UHMWPE—one on the exterior of the other—so that the wear resistance is increased. In one or more embodiments, which may be combined with other embodiments, the inner-most exterior layer is a different color than the exterior-most exterior layer of the unit pouch. In such instances, the visual distinctness of different colored layers may signal that the exterior-most external layer of the sensor tag is damaged and the sensor tag may need replacement before the unit pouch is fully breached.

In one or more embodiments, which may be combined with other embodiments, the unit pouch may comprise, consist, or consist essentially of a woven fabric. In one or more embodiments, which may be combined with other embodiments, the unit pouch may comprise, consist, or consist essentially of a non-woven fabric. In one or more embodiments, which may be combined with other embodiments, the unit pouch may comprise, consist, or consist essentially of a solid film. The unit pouch may comprise or consist essentially of one or more material that is resistant to abrasion, scoring, cutting, and tearing, and has relative low surface friction compared to other fabrics or films.

In one or more embodiments, which may be combined with other embodiments, the unit pouch may a hydrophobic material (that is, repels a mass of water in contact with its surface, for example, a water droplet). “Hydrophobic” is defined for the purposes of this application as a material that creates with a static water droplet a static contact angle (θ) that is greater than 90 degrees.

In the context of this application, a “film” is a relatively “thin” (that is, the material has a thickness dimension that is at least an order of magnitude, and usually several orders of magnitude, smaller relative to the length and width dimensions) sheet of material. A thickness of a film may range from nanometers (nm) to millimeters (mm) in scale, such as in a range of from about 1 to 25 microns (μm; micrometers). In the context of this application, a film often comprises a polymer, such as, but not limited to, polyethylene (PE), polypropylene (PP), polyester, and thermoplastic polyurethane (TPU). A film may be axially oriented or non-oriented; comprise a thermoplastic or a thermosetting material; comprise one or more materials; and may be made using various polymer processing techniques, including, but not limited to, roll coating, spray coating, extrusion, and evaporation. A “film” may also be referred to as a “film layer”; in the case of a polymer-comprising film it may be referred to as a “plastic film.”

A “polymer” is an organic material composed of molecules of monomers chemically linked together. Polymers in the solid form may be either thermosets (that is, cross-linked, 3-dimensional networks of polymeric material that cure and have a non-melting structure) or thermoplastics (that is, a non-or mostly-non cross-linked polymer material; may be re-melted; sets again by cooling).

In regards to a polymeric material, to “cure” and “curing” means that a chemical reaction occurs that transforms a pre-thermoset polymer material into the thermoset polymer material. The pre-thermoset polymer material may be a polymer material itself, such as a thermoplastic; however, upon curing the thermoplastic is irreversibly chemically modified into a thermoset material. This is distinguished from merely cooling or heating a thermoplastic polymer that transitions between a solid or semi-solid state to a molten or fluidic state. Thermoset polymer precursors, including in some cases monomers and in other cases oligomers that will form the finalized thermoset polymeric material, are chemically transformed during the curing process. The properties of a pre-thermoset polymer resin irreversibly changes by exposing the resin to a thermal; a radiation, for example, ultraviolet light, photo-pulse, or visible light; or a chemical treatment to initiate the change. Curing may be accomplished by the addition of curable cross-linking agents, which are often used to convert a thermoplastic polymer into a thermoset polymer. Curing may occur with or without the addition of a catalyst, proton, or electron donor. Curing may occur without or without supplemental heating of the thermoset polymer precursors.

In one or more embodiments, which may be combined with other embodiments, the material of the unit pouch comprises, consists, or consists essentially of one or more of a polyethylene (PE), such as an ultra-high molecular weight polyethylene (UHMWPE); a liquid crystalline polymer (LCP); an aromatic polyamide (“aramid”); a nylon, such as nylon 6 and nylon 66; a polymer-coated, such as thermoplastic polyurethane (TPU), natural material, such as a cotton, wool, or leather material or blend of material; a polypropylene; a polyurethane; a polyester; a polyacrylic; a rayon; a fluorinated polyethylene, such as polytetrafluoroethylene (PFTE); and combinations thereof. An example of a PTFE fabric is sold under the brand name Gore-Tex® (W. L. Gore & Associates, Inc.; Newark, Delaware). An example of a long-chain polyurethane-based fabric is generically known as “spandex” and “elastane”. Examples of aramids, which include para-aramids and meta-aramids, include materials provided under the names Kevlar® (consisting essentially of polyparaphenylene terephthalamide) and Nomex® (both E. I. du Pont de Nemours and Company; Wilmington, Delaware). An example of a liquid crystalline polymer, which include both main chain LCPs and side chain LCPs, is provided under the name Vectran® (Kuraray Co., Ltd.; Kurashiki City, Japan).

In one or more embodiments, which may be combined with other embodiments, the material of the unit pouch comprises, consists, or consists essentially of a UHMWPE. An example of a useful UHMWPE is available under the name Dyneema® (DSM IP Assets B.V.; Heerlen, The Netherlands). A UHMWPE is type of polyolefin made up of relatively long chains of polyethylene (PE) compared with other grades. UHMWPE may also be referred to as either a high-modulus polyethylene (HMPE) or a high-performance polyethylene (HPPE). The molecular weight (Mw) of UHMWPE is often determined and expressed as “intrinsic viscosity” (IV), which is typically in a range of from about 4 deciliters per gram (dl/g) to 50 dl/g, such as in a range of from about 8 to about 40 dl/g. A UHMWPE polymer molecule is generally appreciated to have a reacted monomer unit number anywhere within a range of from about 100,000 to 250,000 monomer units. The molecular mass of a polymer molecule of UHMWPE is generally appreciated to be in a range of from about 3.5 to 7.5 million atomic mass units (amu).

In one or more embodiments, which may be combined with other embodiments, the material of the unit pouch is a combination of two or more materials. In one or more embodiments, which may be combined with other embodiments, the plurality of materials comprising the unit pouch is a laminate. For example, a first layer may be laminated onto a second layer, with both layers being made of different materials. An example of a laminated or composite material useful as a unit pouch material what has been referred to as “cuben fiber”. Cuben fiber is a composite material of a UHMWPE woven fabric laminated on at least one side with at least one layer of a plastic film, such as a polyester or polyvinyl fluoride (PVF). Usually both sides of the UHMWPE woven fabric are laminated, sandwiching the UHMWPE woven fabric between the laminating external layers. Coupling or connecting individual layers of materials is performed through well-appreciated materials and polymer processing techniques, such as the use of heat rolling, melt bonding, and spray adhesion.

In one or more embodiments, which may be combined with other embodiments, the plurality of materials comprising the unit pouch is an interwoven fabric. For example, the unit pouch may comprise an interwoven fabric material of UHMWPE and nylon. Another example is that the material of the unit pouch may comprise an interwoven material comprising polyparaphenylene terephthalamide, a nylon, and a spandex fibers. Such multi-fiber interwoven materials may exploit in part the desirable attributes of the individual materials, such as the cut and abrasion resistance of UHMWPE and the flexibility and the color retention of nylons.

In one or more embodiments, which may be combined with other embodiments, a coupling or connection on the unit pouch is made chemically. For example, as seen in FIGS. 1A-B, an adhesive coupling 1024 along an edge of the positioning tag 10 is the product of an adhesive being previously applied to edges of the material comprising the unit pouch to bond two edges together. In some instances, the adhesive may be introduced directly onto the portions of the material being mated, such as in a double-sided adhesive film. In other instances, the adhesive may be applied to the exterior where the portions of the material being mated meet. In FIGS. 1A-B, the adhesive coupling 1024 appears to couple separate portions of one or more materials comprising the unit pouch 1000, assisting in configuring the overall shape of the unit pouch as a containing structure as well as defining in part the bounds an interior void. In this case, the adhesive coupling also defines in part the outer boundary of the unit pouch just as the portion of material does. The adhesive coupling may be resistant to liquids and solids and prevent either or both from passing into or from the unit pouch.

An “adhesive” is a polymeric resin used to couple two materials together, such as, but not limited to, set reinforcing fibers into a sheet or to bond layers to one another for a laminate composite. Adhesives utilized in this application are preferably non-waterproof/breathable (non-W/B) resins. Common adhesives include, but are not limited to, epoxies, thermoplastic polyurethane (TPU), silicones, low-density polyethylene (LDPE), phenolics, polyimides, cyanoacrylates, acrylics, polyethylene-vinyl acetate (PEVA), polyvinyl acetate (PVA), single- and double-sided films and tapes (also known as pressure adhesives), and polyethylene-methyl acrylate (PEMA). In one or more embodiments, which may be combined with other embodiments, an “adhesive film” may be utilized to describe a film that is configured to adhere one or more adjacent layers to each other, such as part of a composite material or as a laminate, such as coupling two layers together in a coupling layer between two other materials.

In one or more embodiments, which may be combined with other embodiments, a coupling or connection on the unit pouch is made mechanically. For example, a mechanical coupling may include a separate fiber or filament that is laced or sewn into the material comprising the unit pouch to bind separate portions of the unit pouch together. As seen in FIGS. 1A-B, there a midstitch 1016 that comprises a fiber or filament traverses the width of the unit pouch 1000. The midstitch 1016 creates a physical separation between an upper attachment section 1010 (“attachment flap”) and a lower sensor pouch section 1020 (“sensor pouch”). The midstitch 1016 also assists (along with the previously described adhesive coupling 1024) to restrain protective barrier 3000 (containing positioning unit 2000) within sensor pouch 1020. The midstitch 1016 is also shown coupling a top edge of an optional access flap 1026 to the unit pouch 1000. There are other mechanical couplings or connections apparent in FIGS. 1A-B. Eyelet stitching 1018 couples eyelet or grommet 1014 in the attachment flap 1010. Other mechanical coupling means include, but are not limited to, staples, snaps, screws, magnets, clamps, nuts and bolts, non-adhesive films, such as “shrink wrap”, wire, and tie straps.

The optional access flap 1026 lays on the exterior surface of the unit pouch 1000. The access flap 1026 typically lays on the exterior surface of the unit pouch 1000 and provides some restriction to an optional communications port access 1028, to be described forthcoming.

In one or more embodiments, which may be combined with other embodiments, a “fiber”, “filament”, and “monofilament” refers to a filamentary material usually of a length that is relatively greater in length versus the diameter. Filaments (or individual fibers) are separable from fiber bundles, or yarn, by various processes. The material of a fiber or filament may comprise, consist, or consist essentially of one or more of PE, LCP; aromatic polyamide, nylon, a polymer-coated natural material, PP, TPU, polyester, polyacrylic, rayon, fluorinated polyethylene, and combinations thereof.

In one or more embodiments, which may be combined with other embodiments, a fiber of filament may further be laminated. Such a lamination of the fiber or filament may be made before, during, or after installation into the unit pouch. Lamination before use is well appreciated in the fiber and polymer processing arts. Lamination during or after installation into the unit pouch may be accomplished by a number of means, such as utilizing a sealing adhesive or by intruding post-fill material into the unit pouch, as will be described forthcoming. This may provide additional resistance to fluids and damage, and may provide additional strength to the area where the fiber or filament is utilized, for example, along edges or in a midstich of the unit pouch.

In one or more embodiments, which may be combined with other embodiments, a coupling or connection on the unit pouch is made thermally. A thermal coupling or connection may be made through “heat bonding” or “polymer welding”. Heat bonding is often performed by applying localized heating to an elevated temperature of the material comprising the unit pouch at the point of where the coupling or connection is to be made along with an adhesive material. The elevated temperature is such that the adhesive material softens, such as greater than its glass temperature (T_{g}) of a thermoplastic polymer, and even potentially melts, such as greater than its melt temperature (Tₘ). Although not wanting to be bound by theory, it is believed that in some instances the material comprising the unit pouch at an elevated temperature may begin to break down certain chemical bonds and recombine with compounds on the other surfaces, effectively creating self-adhesion via crosslinking. At a temperature greater than Tₘ, the heated portions of the material forming opposing surfaces of the unit pouch may partially melt blend with one another and, upon cooling thereafter, fuse physically together and to form a unitary component.

In one or more embodiments, which may be combined with other embodiments, the unit pouch is a singular object with no connections or coupling that define the configuration of the unit pouch. Such a configuration of the unit pouch may be made through one or several well-appreciated polymer processing techniques, such as, but not limited to, spray molding, injection molding, or dip casting. The unit pouch may be formed around the protective barrier and any exposed portion of the positioning unit as a single form that is free of any open edges or surfaces that require coupling or connection to isolate the interior void from the exterior environment. Forming a unit pouch that lacks any opening to the interior void that may require later coupling or connecting may act as a mitigation to avenues of potential leakage into the unit pouch or loss of the positioning unit from the unit pouch except through catastrophic failure or significant penetration of the exterior surface of the positioning tag.

Unit pouch 1000 of positioning tag 10 has several attributes and features, some of which are optional. Broadly describing the unit pouch 1000 as shown in FIGS. 1A-B, there are two “subsections”: attachment flap 1010 and sensor pouch 1020. Each subsection has a features for effecting the use of the positioning tag 10. For example, attachment flap 1010 is fabricated of a material comprising the unit pouch, such as unit pouch 1000. The attachment flap 1010 is intended to be flexible yet strong and tear-resistant, and resilient enough not to degrade after repeated exposure to the environment and animal activities.

A tag affixing device (not shown) may in part pass through an eyelet or grommet 1014 provided as part of the attachment flap 1010 to couple the sensor tag to an animate or inanimate object. Eyelet or grommet 1014, which is an optional feature, is configured as part of attachment flap 1010 so as to not cause stretching or tearing of the material of the attachment flap 1010 even under extended or rough use. As shown in FIGS. 1A-B, the eyelet or grommet 1014 is at least coupled to attachment flap 1010. Eyelet or grommet 1014 permits an object, such as an attaching mechanism (not shown) of an attaching device, to traverse through the attachment flap 1010 without contacting or penetrating the layers of material comprising the attachment flap 1010. This may prevent wear and degradation of the attachment flap by reducing direct strain on the material comprising the attachment flap 1010.

As previously provided, sensor pouch 1020 retains the positioning unit 2000 within protective barrier 3000. As shown in FIGS. 1A-B, there is also as previously described a coupled access flap 1026 that permits selective access to optional communications port access 1028. The coupled access flap 1026 of communications port access 1028 in some instances is oversized to fully cover the communications port access 1028. In some instances, the communications port access 1028 permits physical access to an optional physical communications coupling on the positioning unit 2000.

Also shown within sensor pouch 1020 is an optional “post-fill” material 1022. In one or more embodiments, which may be combined with other embodiments, the sensor pouch contains a post-fill material. The post-fill material may be introduced into the sensor pouch after the positioning unit and the protective barrier are introduced into the interior void. The post-fill material may be utilized to occupy any remaining empty or void space within the sensor pouch to prevent the accumulation of dirt or water within the positioning tag. The post-fill material may act to laminate or plug any coupling or connective surface that does not have full sealing integrity by back-filling such spaces and gaps. In addition, the post-fill material may secure and prevent the protective barrier from moving by occupying any remaining empty space within the sensor pouch. In instances where there is both post-fill material and a communications port access, the post-fill material in part defines the communications port access, such as shown in FIGS. 1A-B.

In one or more embodiments, which may be combined with other embodiments, a post-fill material comprises the same material as the protective barrier; in other embodiments, the post-fill material comprises a different material than the protective barrier. For example, the protective barrier may be comprised of a dense closed-cell foam to protect the integrity of the positioning unit; however, the post-fill material may be a low-density material only meant to occupy open space. The post-fill material may be comprised of a relatively inexpensive yet lightweight filling material to cushion the positioning unit, such as cotton, wool, or fiberglass.

FIGS. 1C-D are schematic drawings of a front and side views, respectively, representing a gas composition tag, which is an embodiment of a sensor tag. Gas composition tag 50 is shown with a front view in the upper image and a side view in the lower image. Reference to gas composition tag 50 may be made to one or both views simultaneously.

Most of the aspects of FIGS. 1C-D gas composition tag 50 are similar to positioning tag 10 of FIGS. 1A-B, as like numbers reference like features. Gas composition tag 50 is shown having three components related to one another, such as through containing, coupling, or connection: a gas composition unit pouch 1500 (“unit pouch”), a gas composition unit 2500, and a protective barrier 3500 In FIGS. 1C-D, gas composition unit 2500 is shown contained within protective barrier 3500, and both protective barrier 3500 and gas composition unit 2500 are located within a portion of the unit pouch 1500 (both are shown in relief). The midstitch 1516 creates a physical separation between an attachment flap 1510 and a sensor pouch 1520. Eyelet stitching 1518 couples eyelet or grommet 1514 in the attachment flap 1510. Adhesive coupling 1524 is present along some of the edge of gas composition tag 50. Optional “post-fill” material 1522 positions gas composition unit 2500 and eliminates voids from within unit pouch 1500.

Optional access flap 1526 is secured to the back side of the exterior surface of the unit pouch 1500 using a backstitch 1525 for the top edge but also a mechanical closure 1527, such as a snap button or fastener, to secure the bottom edge. Optional access flap 1526 provides accessibility to the back of gas composition unit 2500 through using power and communication prongs recess 3532.

FIGS. 1C-D shows that the unit pouch 1500 for gas composition tag 50 has several different features than the unit pouch 1000 of positioning tag 10. In one or more embodiments, which may be combined with other embodiments, at least a portion of the material comprising the sensor pouch is different than the material comprising the attachment flap. From the front view of FIGS. 1C-F, one may note an apparent physical configuration difference between the material comprising the attachment flap 1510 and the sensor pouch 1520. As shown in both the front and side views of FIGS. 1C-D, the entire front portion of the sensor pouch 1520 comprises a second material that is different than the material comprising the remainder of the unit pouch 1000.

In one or more embodiments, which may be combined with other embodiments, the at least a portion of the material comprising the sensor pouch than is different than the material comprising the attachment flap has a greater gas permeability than the material that comprises the attachment flap. Given that the intended purpose of a gas composition tag is to detect the presence of and relative amount of one or more components, such as methane, present in the air around the gas composition tag, the material of the unit pouch proximate to the detection surface of the gas composition unit may be comprised of a material that has greater gas permeability or “breathability” than the remaining material comprising the remainder of the unit pouch. As seen in FIGS. 1C-D, the entire front section of the unit pouch 1520 comprises a material, which in this instance has greater breathability, that is different than the material comprising the back section of the unit pouch 1520 and the attachment flap 1510, which in this instances has greater resistant to abrasion, scoring, cutting, and tearing. Sensor pouch stitching 1517 with a fiber or filament couples the breathable material to the remaining material that comprises the unit pouch 1500.

There are a variety of useful interwoven fabrics that may comprise materials that have a suitable level of breathability for a gas composition unit and yet still have an appropriate amount of resilience or strength for use as part of a sensor tag. A non-limiting example includes a 50/50 interwoven fabric of a UHMWPE and a nylon. Another example includes an interwoven material comprising polyparaphenylene terephthalamide, a nylon, and a spandex fibers.

Although shown in FIGS. 1C-D as comprising the entire front section of the sensor pouch, a breathable material associated with the detection surface of the gas composition unit may not need to cover the entire sensor pouch or even the entire front section of the sensor pouch. For example, a shaped patch of material that has greater breathability, such as a circle, an oval, or a square, may be coupled or connected to a portion of the front section of the sensor pouch, such as adjacent to where the detection surface of the gas composition unit is to be positioned internally to the unit pouch. A portion of the material comprising the front section of the sensor pouch may be removed, liked-shaped patch of material having greater breathability introduced into the void, and the patch coupled or connected to the remainder of the material comprising the sensor pouch. Such a solution may minimize the amount of breathable material that is on the unit pouch. As well, such a configuration may permit the patch of breathable material to be replaced if the material becomes fouled or damaged while the remainder of the unit pouch continues to be serviceable. In one or more embodiments, at least a portion of the sensor pouch is comprised of a material of suitable breathability for a gas composition tag to operate unimpeded.

FIGS. 1D-E are schematic drawings of a front and side views, respectively, representing a second gas composition tag, which is an embodiment of a sensor tag. Second gas composition tag 60 is shown with a front view in the upper image and a side view in the lower image. Reference to second gas composition tag 60 may be made to one or both views simultaneously.

Most of the aspects of FIGS. 1D-E second gas composition tag 60 are similar to positioning tag 10 of FIGS. 1A-B and gas composition tag 50 of FIGS. 1C-D, as like numbers reference like features. Second composition tag 60 is shown having three components related to one another, such as through containing, coupling, or connection: a gas composition unit pouch 1600 (“unit pouch”), a gas composition unit 2500, and a protective barrier 3500 In FIGS. 1D-E, gas composition unit 2500 is shown partially contained within protective barrier 3500, and both protective barrier 3500 and gas composition unit 2500 are located within a portion of the unit pouch 1600 (both are shown in relief). The midstitch 1616 creates a physical separation between an attachment flap 1610 and a sensor pouch 1620. Eyelet stitching 1618 couples eyelet or grommet 1614 in the attachment flap 1610. Adhesive coupling 1624 is present along some of the edge of gas composition tag 60. Optional “post-fill” material 1622 positions gas composition unit 2500 and removes voids from within unit pouch 1500. Optional access flap 1626, which provides access to power and communication contacts prongs 3532, is secured to the back side of the exterior surface of the unit pouch 1600 using backstitch 1625 and a mechanical closure 1627.

Optional protection flap 1628 is secured to the front side at the midstich 1616. In the upper figure of FIGS. 1D-E, the backside of the protection flap 1628 is shown as the protection flap 1628 is positioned in an upward direction to provide a view of the front of the sensor pouch 1620. In the lower portion of FIGS. 1D-E, the protection flap 1628 is shown in FIGS. 1D-E laying freely over most of the front side of the sensor pouch 1600, hanging loosely in front of porous fabric section 1623.

In one or more embodiments, which may be combined with other embodiments, at least a portion of the material comprising the sensor pouch defines an area comprising one or more holes, where each of one or more holes is configured such that a gas or vapor is permitted to freely traverse through each hole and a liquid is not. As shown in the upper figure of FIGS. 1D-E, a square-shaped area of repeating pores 1623 is positioned on the sensor pouch 1620 just in front of where the detecting surface of the gas composition unit 2500 is located within the second gas composition tag 60.

The size of the one or more holes in the sensor pouch that permits gas permeability are configured to permit gas molecules to contact the detecting surface of the gas composition unit, including both methane and water in the vapor form also to prevent liquids, such as liquid water, from passing through the one or more holes. In one or more embodiments, which may be combined with other embodiments, the dimensional width of the one or more holes through the material comprising the sensor pouch is in a range of from about 1 nanometer to 100 microns, such as in a range of from about 10 nm to 50 μm, such as in a range of from about 50 nm to 1 μm, such as about 100 nm to 1 μm, such as about 100 nm, such as about 200 nm, such as about 300 nm, such as about 400 nm, such as about 500 nm, such as about 600 nm, such as about 700 nm, such as about 800 nm, such as about 900 nm, and such as about 1000 nm (about 1 μm).

Although not wanting to be bound by theory, it is believed a combination of not only the surface tension of a droplet of water on the surface of the material comprising the sensor pouch, such as a UHMWPE or polyparaphenylene terephthalamide the along with the dimensional width of the hole in which the water droplet is interacting (for example, diameter or diagonal) generally prevents capillary and pressure-driven forces to drive the liquid water through the hole and into the sensor pouch. This is in light that most liquid water exposures such holes may receive are short in period, such as a droplet rolling down the exterior surface, sprayed onto the surface, or immersion into a shallow pool of water.

The one or more holes in the material comprising the sensor pouch may be formed using any well-appreciated fabric and polymer-polymer processing techniques. Holes may be formed using a mechanical technique. For example, a lance or needle, to part the weave or puncture the sheet or laminate that comprises the sensor pouch. Holes may be formed using a chemical technique. For example, a dry chemical etchant (that is, an acid) that is ultraviolet or photo light activated may be applied in the size and pattern desired, and then exposed to light to enable the acid to controllably dissolve the material to form the one or more holes. Holes may be formed using a thermal technique. For example, a laser may be utilized to ablate material of an appropriate size and pattern. Forming holes utilizing laser-pattering may have certain advantages in processing woven materials comparing polymer fibers as the heat from the action of material removal may cause the adjacent remaining material to fuse together. This may eliminate potential loose ends and prevent fraying from imitating at the edge of the hole.

In one or more embodiments, which may be combined with other embodiments, at least a portion of the sensor pouch defines one or more holes that permits a liquid to drain from an interior of the sensor pouch to an exterior of the sensor unit. In some configurations and uses of a sensor tag, there may be advantages to have holes, such as drain holes 1629 of FIG. 1D. Drain holes may permit a liquid, such as water, that may accumulated inside a sensor pouch to drain from the sensor pouch. For example, in instances where gas or vapor is permitted to pass into the sensor pouch of a sensor tag, a change in environmental conditions may cause condensation of previously-vaporized water to occur within the sensor pouch. One or more drain holes may permit liquid water to freely egress from the sensor pouch and help dry the interior of moisture relative to the exterior environment. As well, such liquid drainage holes may also permit liquids as well as dissolved and entrained solids to be carried out, such as when the sensor pouch is immersed in or is sprayed with liquid water.

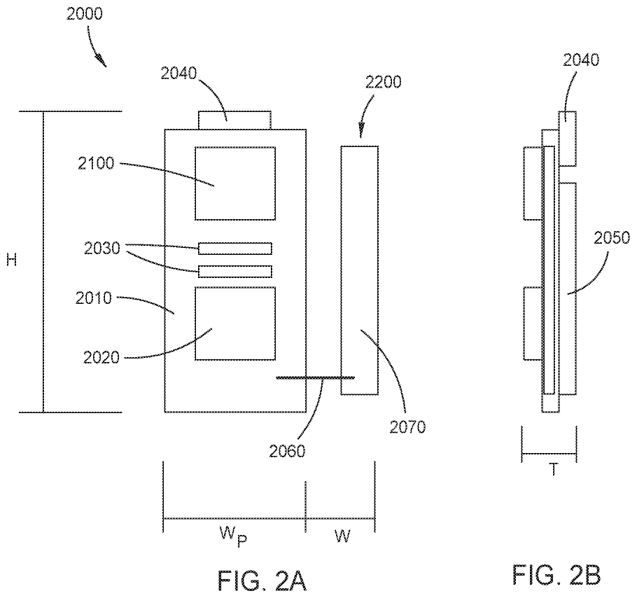

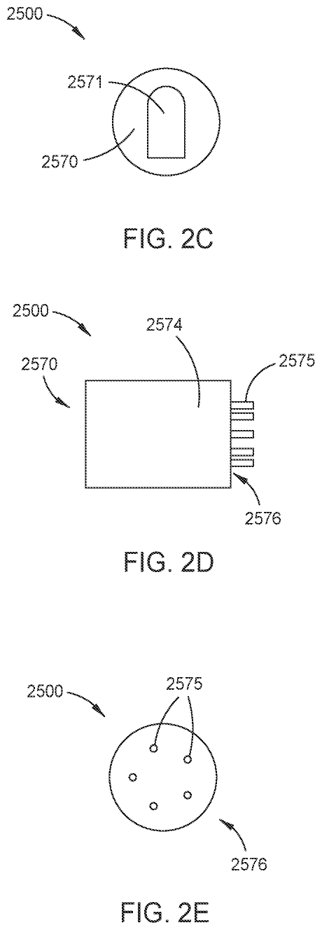

FIGS. 2A-B are schematic drawings of a front and side views, respectively, representing a positioning unit, such as positioning unit 2000 provided for previously in FIGS. 1A-B. Positioning unit 2000 may be comprised of a commercially-available sensor that is configured to detect a signal transmission from one or more known locations. The positioning unit may passively or actively assist in determining the location of the positioning sensor at any given time relative to the position of the one or more fixed or moving devices transmitting a detectable signal. Well-appreciated means for determining the location of a positioning unit include, but are not limited to, the Global Positioning System (GPS), which utilizes the relative position of one or more GPS-signal broadcasting satellites, and the Global System for Mobile Communications (GMS) and General Packet Radio Service (GPRS), both of which are based upon cellular tower signal reception and transmission. As well, one or more wireless fidelity (Wi-Fi) transmitters may be used as part of a wireless local area network (WLAN) to triangulate instantly or determine over a given period using pulse-delay determinations to locate a receiving unit. As one may appreciate, there may be other means for determining location with suitable precision for a positioning unit, and such other means are not limiting. In addition, it is envisioned that more than one methodology may be combined to act together in concert.

FIGS. 2A-B shows several non-limiting aspects for an example positioning unit, such as positioning unit 2000. As seen from the front view of FIGS. 2A-B, positioned on a rigid printed circuit board (PCB) 2010 are several components useful for one or more operation performed by positioning unit 2000. As seen, mounted on the front side of the rigid PCB 2010 a microchip processor 2020 and several memory chips 2030 are included. Note that for the sake of clarity that wiring, connections, couplings, and circuitry of the PCB and generally a computer-based circuit is not shown but that one of skill in the art appreciates it is present and configured for overall functionality of the positioning unit.

As seen from the side view of FIG. 2B, an optional physical communications port 2040 is connected to the rigid PCB. Examples of potentially useful physical communication ports may include, but are not limited to, a universal serial bus (USB) port or a network interface controller (NIC) port. If a physical communication port is not utilized, then the sensor unit would generally appreciated to have a wireless configuration for transmitting and receiving data, such as through Wi-Fi or Bluetooth circuit and antenna. Also seen from side view is power source 2050, such as a battery cell, connected to the rigid PCB 2010.

In one or more embodiments, which may be combined with other embodiments, at least a portion of the sensor unit is fabricated on a rigid PCB. In one or more embodiments, which may be combined with other embodiments, at least a portion of the sensor unit is fabricated on a flexible PCB. As the name implies, a “flexible” PCB is a printed circuit board sandwiched between polymer insulating layers that permits bending and twisting of the printed circuit board without damaging or crimping the circuit pathways. The ability to support repeated bending and twisting of a circuit board may be advantageous for use with a senor unit mounted on live animals that freely moves about, or on a sensor unit where a number of collisions are expected. Although only showing in FIGS. 2A-B a portion of the positioning unit 2000 being made of flexible PCB 2070, in one or more embodiments, which may be combined with other embodiments, the sensor unit may be entirely fabricated of flexible PCB.

Although shown in this instance as being connected to the rigid PCB 2010, a power source, such as power source 2050, in other instances may be physically separated from the positioning unit 2000 and coupled to the positioning unit 2000 using wires and solder or a reciprocal power coupling. One may appreciate that the power source may be sized not only for the amount of energy that is utilized to receive and transmit signals to and from the positioning unit but also for the operational longevity of the positioning unit.

In one or more embodiments, which may be combined with other embodiments, the power unit may comprise a non-rechargeable battery or primary cell, such as a dry-cell chemical battery. In one or more embodiments, which may be combined with other embodiments, the power unit may comprise a rechargeable battery or secondary cell, such as, but not limited to, a lithium-ion (LiOn), nickel-metal hydride (NiMH), or nickel-cadmium (NiCd) chemical battery.

In one or more embodiments, which may be combined with other embodiments, where a rechargeable battery or secondary cell is utilized as a power source, the power source may further comprise a power recharging system. In one or more embodiments, which may be combined with other embodiments, the power recharging system may further comprise an inductive charging coil. In one or more embodiments, which may be combined with other embodiments, the power recharging system comprises a radio frequency (RF) wireless charging receiving antenna. As non-limiting examples, the RF wireless charging receiver may be configured for either far-field (FF) RF wireless charging or near-field (NF) RF wireless charging. In one or more embodiments, which may be combined with other embodiments, the power recharging system comprises a kinetic charging system. For example, a kinetic charging system may include combination of a pinion, a gear, a pendulum, an electrical generator to generate electrical power through motion of the sensor tag.

There are several benefits of having a power recharging system in combination with a rechargeable battery or secondary cell. The physical size and weight of the rechargeable battery or secondary cell may be smaller than a primary battery or cell. The power recharging system may be configured such that the act of regenerating the charge of the secondary battery or cell does not affect the animal or package to which the sensor tag is attached. For example, induction or RF reception may occur while an animal is feeding or a package is stored. A kinetic charging system is based upon motion; therefore, any time the sensor tag is being moved with the package, for example, an animal shaking its head or a package being transported on a tractor trailer, the system will charge. In instances where there is a power recharging system, the power recharging system may be configured to provide all the power to a sensor unit and direct any excess power to the secondary cell during power regeneration. The power recharging system may permit a sensor unit to operate for long periods as compared to a primary battery or cell without requiring replacement or intervention. In some jurisdictions, rechargeable batteries or cells are recyclable, which may reduce the long-term impact on the use of the sensor unit on the environment and may provide some end-of-life financial return.

Returning to the front view of FIG. 2A, also shown are two antennas associated with positioning unit 2000. Mounted on the rigid PCB 2010 is represented a ceramic GPS antenna 2100 configured for use with a GPS-based tracking system. Mounted on the flexible PCB 2070 is a wire loop GSM antenna 2200 configured for use with a cellular network. The flexible PCB 2070 is coupled to the rigid PCB 2010 using a conductive connector 2060. Although neither positioning systems are shown in full detail, a person of skill appreciates that each has a functional supporting circuit, appropriate software instructions, and access to power to energize and operate the functional support circuit, including receipt and potential transmission of signals from the sensor unit, if appropriate. In one or more embodiments, which may be combined with other embodiments, the sensor unit does not have a transmission antenna. In such a case, if an antenna is present it only may be useful for passively determining location, and then such a determined position is recorded in an on-board storage device for correlation with detected signals, such as for gas composition, time, or other quantitative, distinctive value.

In one or more embodiments, which may be combined with other embodiments, the sensor has a plurality of antenna, where each antenna transmits, receives, or both a signal at a different RF frequency. In one or more embodiments, which may be combined with other embodiments, the sensor is a signal relay, where the signal relay is configured with a first antenna and a second antenna, and where the first and the second antennas both are configured to transmit and receive a signal at different frequencies from one another. In one or more embodiments, which may be combined with other embodiments, a first antenna may be configured to transmit or receive a signal at a frequency that is in a range of from about 300 to 500 mHz (milliHerzt), and a second antenna may be configured to transmits, receives, or both a signal at a frequency that is at a greater frequency than the first antenna. For example the relatively higher second frequency may be in a range suitable for Wi-Fi, cellular, or Bluetooth signal transmission and reception.

FIGS. 2C-E are schematic drawings of a front, side, and back view, respectively, representing a gas composition unit, such as gas composition unit 2500 provided for previously in FIGS. 1C-D and 1E-F. Gas composition unit 2500 may be comprised of a commercially-available sensor gas detection sensor that is configured to detect the presence, relative amounts, or both, of one or more components in a gas or vapor that comes into physical contact with the sensor surface. The gas composition unit may passively or actively assist in determining the time of detection and the period of exposure of the detected component. The gas composition unit may be configured to transmit to transmit a wireless signal correlated on a response generated by detecting a given concentration of a component or by failure to detect a given concentration of a component. In one or more embodiments, which may be combined with other embodiments, the gas composition unit may be configured to detect a concentration of a vaporized chemical in air.

For the purposes of this application, the gas composition unit is described as a system that can detect methane in air within a given concentration range; however, other components that may be present in air may be detected using one or more gas composition units. In one or more embodiments, which may be combined with other embodiments, the vaporized chemical comprises hydrogen. In one or more embodiments, which may be combined with other embodiments, the vaporized chemical comprises methane. In one or more embodiments, which may be combined with other embodiments, the vaporized chemical comprises ethane. In one or more embodiments, which may be combined with other embodiments, the vaporized chemical comprises propane. In one or more embodiments, which may be combined with other embodiments, the vaporized chemical comprises carbon dioxide. In one or more embodiments, which may be combined with other embodiments, the vaporized chemical comprises carbon monoxide. In one or more embodiments, which may be combined with other embodiments, the vaporized chemical comprises ozone. In one or more embodiments, which may be combined with other embodiments, the vaporized chemical comprises nitric oxides (NOx). In one or more embodiments, which may be combined with other embodiments, the vaporized chemical comprises water. In one or more embodiments, which may be combined with other embodiments, the vaporized chemical comprises oxygen. In one or more embodiments, which may be combined with other embodiments, the vaporized chemical comprises ammonia. In one or more embodiments, which may be combined with other embodiments, the vaporized chemical comprises hydrogen sulfide. In one or more embodiments, which may be combined with other embodiments, the vaporized chemical comprises nitrogen. In one or more embodiments, which may be combined with other embodiments, the vaporized chemical comprises radon.

FIGS. 2C-E shows several non-limiting aspects for an example gas composition unit, such as gas composition unit 2500. One, some, or all of the views may be utilized and described simultaneously. As seen from the front view of FIG. 2C, accessible through a rigid shell of a front sensor face 2570 is a gas sensor detection surface 2571. In one or more embodiments, which may be combined with other embodiments, the gas sensor detection surface generates a proportional signal in response to interaction with a concentration of a gas or vapor present in air, such as methane, upon exceeding a pre-determined concentration level. For example, the pre-determined concentration level may be about 50 parts per million volume (ppmv) in air, and the detection range may be in a range of from about 50 to 1000000 ppmv. The middle view of FIGS. 2C-E shows a sensor body 2574 made of a rigid plastic material that contains the operable components of the gas composition unit. Middle and back views of FIGS. 2C-E show power and communications prongs 2575. Power and communications prongs may be coupled to perform such activities as downloading data to an off-line computer or storage unit, recharging an on-board battery or capacitor contained within gas composition unit, and perform calibration verifications. Back view in FIG. 2E shows the power and communications prongs 2575 configured in a geometric pattern; the side view shows the power and communications prongs 2575 extending from sensor rear 2576 away from sensor body 2574.

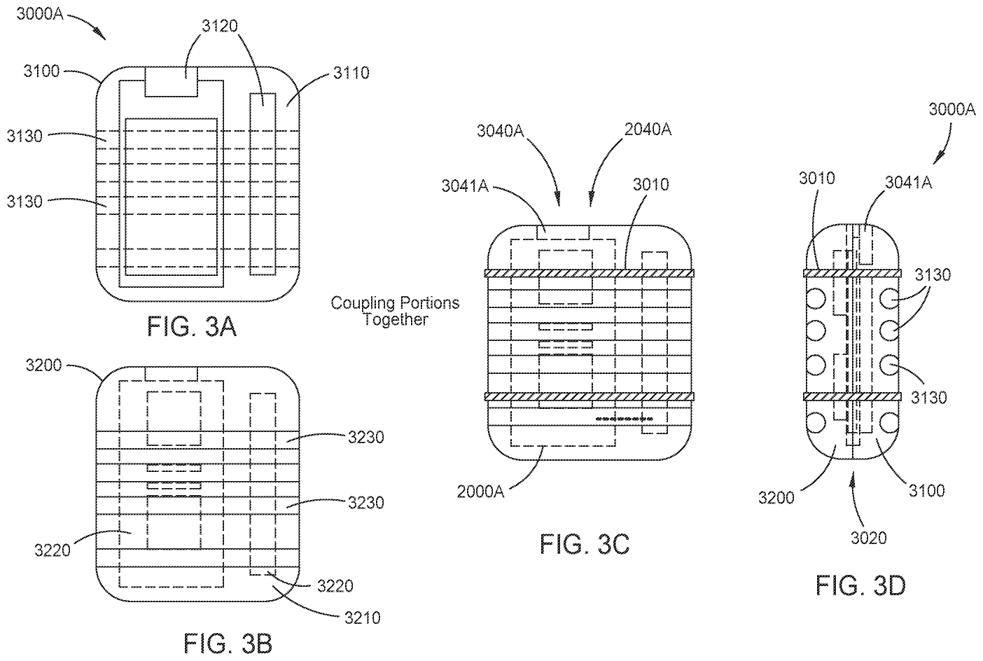

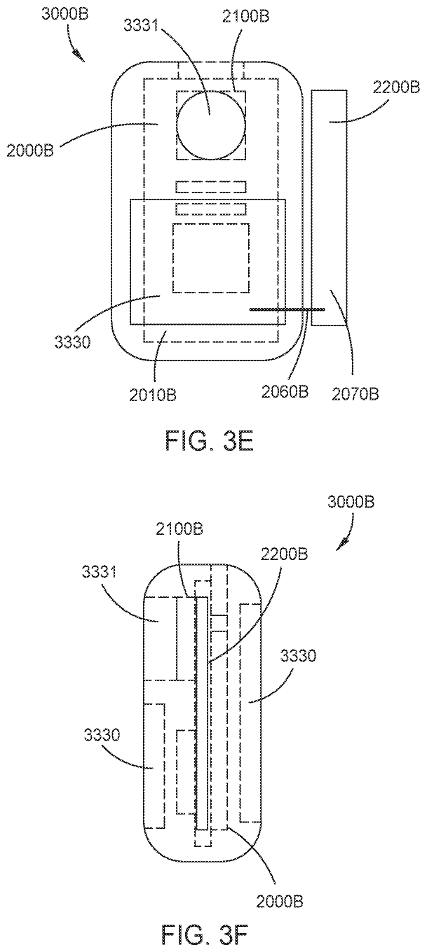

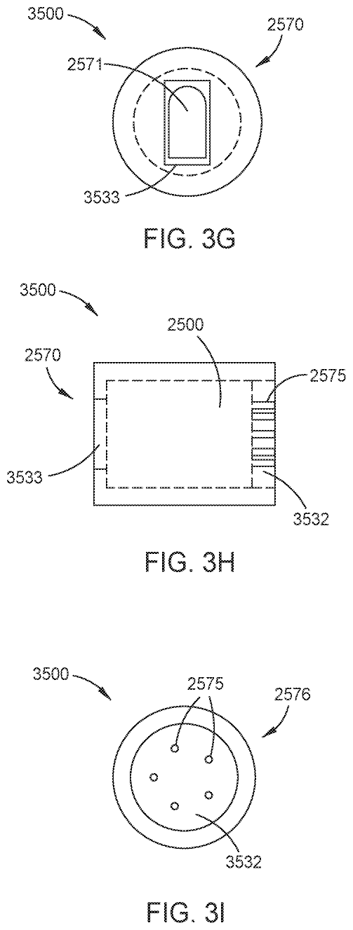

FIGS. 3A-B are schematic drawings representing both a front and a back portion, respectively, of a protective barrier. The top FIGS. 3A represents a back portion 3100 of a protective barrier 3000A. Back portion 3100 is showing an interior-facing surface 3110, which is configured with an optional interior sensor recess 3120. The interior sensor recess 3120 is configured as a negative replica of the back-side of a positioning unit, such as positioning unit 2000 of FIGS. 2A-B. An interior sensor recess may be configured as a negative replica of the back or side part of any sensor unit to be set within the interior sensor recess and frictionally couple with the back portion, preventing the sensor unit from excess movement in reaction to an exterior force acting on the sensor tag that may otherwise damage components of the sensor unit when not secured. The non-recess portion of interior-facing surface 3110 is shown as a flat surface; however, one of ordinary skill in the art appreciates that the surface may have any configuration desired, such as a negative reciprocal configuration, for interfacing with a reciprocal section on front portion 3200, to be described.

Revealed in relief of the same image are several lateral-traversing exterior recesses 3130, in the exterior surface (not numbered) of the back portion 3100. These exterior recesses may be formed either during fabrication of the back portion; by removing material from the back portion after formation, or both. The exterior recesses 3130 are configured such that the overall weight of the positioning tag 10 is reduced versus with the material still being present while not reducing protection from moisture penetration or resistance to physical shock. As a secondary benefit, a series of exterior recesses may provide a handing grip that helps in handling and assembling the plurality of potential portions of the protective barrier.

The bottom FIG. 3B represents a front portion 3200 of a protective barrier 3000A. Front portion 3200 has a similar yet not the same configuration as back portion 3100; however, such a configuration is envisioned. As viewed, front portion 3200 has exterior-facing surface 3210 directed toward the viewer. The optional interior sensor recess 3220 (shown in relief) is configured as a negative replica of the front-side of a positioning unit, such as positioning unit 2000 of FIGS. 2A-B. Several lateral-traversing exterior recesses 3230, similar in form and function as exterior recesses 3130 previously described, make up part of the exterior-facing surface 3210.

In one or more embodiments, which may be combined with other embodiments, the optional interior sensor recess is configured to conform to a maximum length-width-thickness (L-W-T) dimensions of the sensor unit. For example, FIGS. 2A-B shows positioning unit 2000 having a length L, a width W, and a thickness T. An optional interior sensor recess may be configured as a partial negative replica for the positioning unit with these maximum dimensions. Such an optional interior sensor recess may provide a frictional fit for the positioning unit while also eliminating additional protective barrier material, reducing overall weight without compromising moisture/thermal/physical protection to the positioning unit.

Both back portion and front portion comprise a polymer material. In one or more embodiments, which may be combined with other embodiments, the polymer material of the protective barrier is comprised of a thermoset polymer. In one or more embodiments, which may be combined with other embodiments, the polymer material of the protective barrier is comprised of a thermoplastic material. In one or more embodiments, which may be combined with other embodiments, the protective barrier is comprised of two or more polymer materials.

In one or more embodiments, which may be combined with other embodiments, the polymer material is a carbon-based material. A “carbon-based material” is a polymer where a majority of the weight of the polymer (that is, greater than 50 weight percent (wt. %)) is comprised of carbon atoms. In one or more embodiments, which may be combined with other embodiments, the polymer material is a silicon-based material. A “silicon-based material” is a polymer where a majority of the weight of the polymer (that is, greater than 50 wt. %) is comprised of silicon atoms.

In one or more embodiments, which may be combined with other embodiments, the polymer material is an elastomer. An “elastomer” or elastic polymer is a polymer that at room temperature may be stretched to twice its original length more than at least two times and upon release each time returns to at least if not greater than 99% of its original length. An elastic polymer may include both thermoplastic and thermoset elastomers. A non-exclusive list of elastomers includes natural rubbers (NR), styrene-butadiene rubbers (SBR), ethylene propylene diene monomer rubber (EPDM), nitrile rubbers (NBR), polycaprolactone (PCL), butyl rubbers, thermoplastic polyurethane elastomers (TPUs), thermoplastic olefins (TPOs), ethylene-propylene rubbers (EPR), silicone, chloroprene, fluoroelastomers, thermoplastic urethane, styrenic block copolymers, copolyether ester elastomers, polyester amide, polydimethylsiloxane (PDMS), polyisoprene, and polybutadiene.

In one or more embodiments, which may be combined with other embodiments, the polymer material is a foamed material. A polymer foam is a two-phase system (that is, a gas contained within a solid) that contains statistically distributed gas bubbles in the polymer material matrix. Non-limiting examples of foamed polymer materials include foamed versions of polyurethane, polystyrene (PS), polyvinyl chloride (PVC), polyethylene, acrylonitrile-butadiene-styrene (ABS) rubbers, natural rubber, and silicone rubber. Foamed polymer material have numerous advantageous properties for use in the positioning tag, including a reduced density compared to similarly-comprised fully solid materials. Foamed compositions also have relatively greater thermal and sound insulation properties and superior energy absorption (that is, impact resistance) properties to similarly-comprised fully solid materials.

A feature of a foamed polymer materials is the size of the pores versus the overall volume of the material. In one or more embodiments, which may be combined with other embodiments, the foamed polymer materials has a void volume or porosity percentage in a range of from about 50% to about 98% of the volume of the structure, such as 50, 55, 60, 65, 70, 75, 80, 85, and 90 to about 91, 92, 93, 94, 95, 96, 97, and 98% of the volume of the foamed polymer materials, including all range combinations and end points inclusive.

In one or more embodiments, which may be combined with other embodiments, the polymer material is a closed-cell foamed material. In one or more embodiments, which may be combined with other embodiments, the foamed polymer materials has a permeability in a range of from zero to about 10%, such as such as greater than about 0, 1, 2, 3, 4, and 5 to about 6, 7, 8, 9, and 10% permeability. For closed-cell foams, the majority of the cells are not connected together by passageways through the solid portion of the foam and do not share any of their void structure with other cells. One may appreciate that the lack of permeability of closed-cell foams comprising the protective barrier is what makes the material “closed”: the closed-cell structure prevents fluids, such as liquid water or air with moisture, from flowing through the foamed polymer materials and interacting with the positioning unit. The closed-cell structure also prevents liquids from being retained in the foam upon coming into contact. Retention of liquids in a foam would increase the weight of the positioning tag beyond a value suitable for operation of the positioning tag. The closed-cell structure also acts to insulate and reduce the rate of thermal migration. The gases trapped within the pores may provide a similar insulating value as the polymer material entrapping such gases. Such insulation prevents what may be appreciated as “thermal shock”, which may occur when the positioning unit is moved from one temperature environment to a second temperature environment, such as moving from an exterior environment to an interior environment or vice versa. Thermal shock may create separation between the positioning unit and the protective barrier, or the protective barrier from the positioning unit pouch, which may lead to entry pathways for liquids or dirt.

FIGS. 3C-D are schematic drawings of a front and side views, respectively, representing a protective barrier for a positioning unit comprising the front and back portions provided previously in FIGS. 3A-B. Protective barrier 3000A is shown in both front and side view with a positioning unit, such as positioning unit 2000A, contained within (shown in relief). The formed protective barrier 3000A is shown having back portion 3100 and front portion 3200 coupled together utilizing several physical exterior coupling straps 3010. The back portion 3100 and front portion 3200 are configured and positioned relative to one another such that back portion 3100 sits flush with front portion 3200 and vice versa along coupling midseam 3020.

In one more embodiments, the protective barrier, such as protective barrier 3000A, is configured such that a void or access permits limited physical access to the contained sensor unit. For example, protective barrier 3000A is configured with a communications connector access 3040A. Communications connector access 3040A permits physical access to the physical communications port 2040A of positioning unit 2000A. Such an access, unlike a recess, such as recess 3130, provides direct yet limited physical access to a portion of the sensor unit contained within the protective barrier to mitigate any other undesired access, such as by fluids and dirt. Communications connector access 3040A may further comprise a removable seal 3041A around or on top of communications connector access 3040A. This seal may prevent or mitigate debris or liquids from accumulating within communications connector access when not being used for its intended use.

Although not shown in FIGS. 3C-D, the coupling midseam, such as coupling midseam 3020, may further comprise an interior, exterior, or both, seal or barrier to enhance performance of the protective barrier. For example, a hydrophobic tape, such as polytetrafluoroethylene (PTFE) tape, may be utilized all around the exterior of the protective barrier along the coupling midseam to prevent moisture and dirt ingress. In another example, a chemical seal, such as utilizing a double-sided adhesive film or a bonding agent, may be applied to portions of the opposing interior facing surfaces. When the back portion and the front portion of the protective barrier are coupled together, a joining seal is formed.

FIGS. 3E-F are schematic drawings of a front and side view, respectively, representing a protective barrier formed around a portion of a positioning unit. FIGS. 3E-F shows a front and side view of the protective barrier 3000B partially encasing a positioning unit 2000B. Protective barrier 3000B is shown as previously-formed around the positioning unit 2000B such that protective barrier 3000B is effectively encasing almost the entirety of the rigid PCB 2010B portion. The flexible PCB portion 2070B, which comprises the GSM antenna 2200B, remains free.

One may envision that such a protective barrier, such as protective barrier 3000B of FIGS. 3E-F, may be formed around a portion or the entirety of a sensor unit, through well-appreciated polymer processing techniques, such as injection or cast molding. A thermoplastic or thermoset polymer may be applied directly to the surface of the sensor unit and permitted to cure, such as through cooling or reaction, and adhere directly onto the surface of sensor unit. Such a connection between the protective barrier and the sensor unit—direct surface contact (and in some instances adhesion)—reduces not only the volume of the sensor tag but prevents formation of gaps or channels that may permit moisture and dirt to penetrate onto the surfaces of the sensor unit.

As previously noted in FIGS. 3A-B, there may be a number of recesses, such as recesses 3330 of FIGS. 3E-F, formed in the surface of the protective barrier to reduce volume and weight of the sensor tag. In the instance shown in FIGS. 3E-F, there is an additional recess 3331 for the GPS antenna 2100B. GPS antenna recess 3331 is shown configured such that the void is flush with the surface of the GPS antenna 2100B while the protective barrier 3000B around the GPS antenna 2100B provides a fluid seal against the remainder of the ceramic GPS antenna 2100B. Not only does this recess provide for weight avoidance but also prevents any potential interference or blockage to the GPS signal that may be caused by the material of the protective barrier.

In a similar fashion, flexible PCB 2070B comprising the GSM antenna 2200B remains outside of the protective barrier 3000B. The protective barrier 3000B is configured such that it seals against the connector 2060B, leaving the GSM antenna 2200B free from any reception interference while still protecting the supporting GSM antenna circuits present on the rigid PCB 2010B.

FIGS. 3G-I are schematic drawings of a front, side, and back views representing a protective barrier formed around a portion of a gas composition unit. FIGS. 3G-I show protective barrier 3500 partially encasing a gas composition unit 2500. Protective barrier 3500 is shown formed around the gas composition unit 2500 such that only two recesses provide any access to the gas compensation unit 2500; the protective barrier 3500 seals directly against the rest of the gas compensation unit 2500. The first opening in the protective barrier 3500 is a detection surface recess 3533 along the front sensor face 2570. Protective barrier 3500 is configured to partially project forward a “bumper” to prevent glancing physical collision against the gas sensor detection surface 2571 but still permit gas and vapor to directly access the gas sensor detection surface 2571. The second opening in the protective barrier 3500 is a power and communication prongs recess 3532 along the sensor rear 2576. In a similar “bumper” manner, protective barrier 3500 partially projects backwards to provide an inset space such that a coupling may connect with the power and communication prongs 2575 and prevent glancing damage to the power and communication prongs 2575.

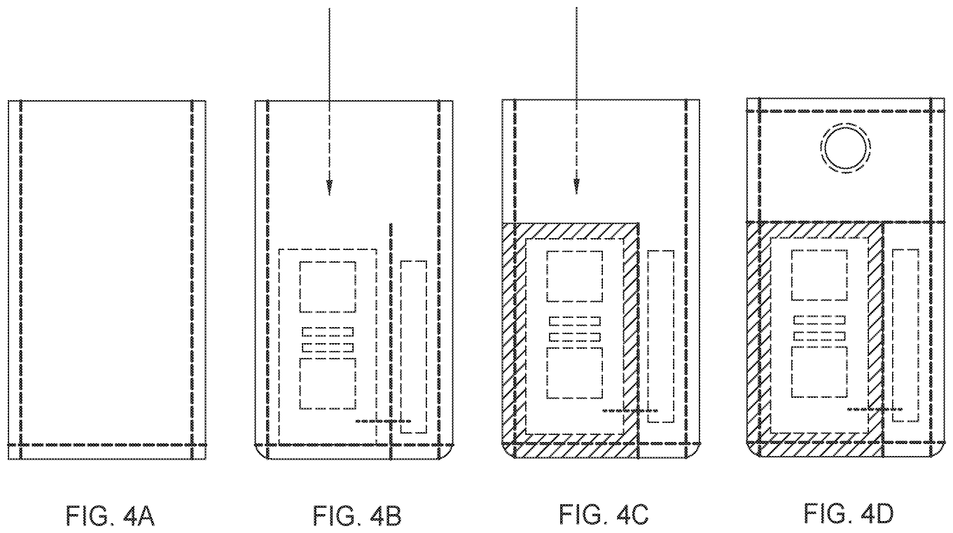

FIGS. 4A-D are a series of schematic drawings representing several portions of a method for fabricating a sensor tag, such as, but not limited to, the positioning tag 10 as provided for in FIGS. 1A-B. Note that such an embodiment method may be applied to one or more other sensor units, such as a gas composition sensor.

In one or more embodiments, which may be combined with other embodiments, a unit pouch is provided. FIG. 4A shows an example of a positioning unit pouch provided that is partially processed for making an embodiment positioning tag. In this instance, the unit pouch is similar in configuration to the unit pouch 1000 of FIGS. 1A-B. The unit pouch of FIG. 4A is shown with filament stitching along several external edges, which binds portions of the material forming the unit pouch together and defines in part an internal void (not shown) into which the positioning unit may be introduced and the protective barrier may form. At this point, the sticking may or may not be laminated, if they are laminated at all during any part of the one or more embodiment methods.

In one or more embodiments, which may be combined with other embodiments, a sensor unit is provided. In one or more embodiments, which may be combined with other embodiments, the sensor unit is provided without a protective barrier. In FIG. 4B, a positioning unit, which is similar in configuration to the positioning unit 2000 of FIGS. 2A-B, is introduced (downward arrow) into the interior of the positioning unit pouch (shown in relief). In this particular embodiment, the positioning unit is shown without a protective barrier coupled or connected to it either in part or in entirety at this stage of the fabrication process. In one or more embodiments, which may be combined with other embodiments, the sensor unit is provided at least partially contained within a protective barrier.

Of note in FIG. 4B, a vertical filament stitching through the unit pouch from the bottom of the unit pouch to above the top of the position unit and in between the flexible and rigid PCB portions is apparent. The vertical filament stitching in this instance may serve several purposes. The vertical filament stitching creates a physical separation between the rigid and flexible PCBs while the positioning unit is located in the unit pouch such that one portion of the positioning unit may undergo a treatment while the other portion is not or is minimally affected by such a treatment, for example, applying a thermoset polymer precursor to form the protective barrier. The vertical filament stitching may also affix the sensor unit in the interior of the unit pouch, making later processing steps for fabrication of the sensor tag easier as the sensor unit is secured. For example, as shown in FIG. 4b, the vertical filament stitching may be configured to cross over but not detrimentally impact the connection of the GSM antenna to the rigid PCB, which may also be the means for securing the positioning unit within the unit pouch.

In one or more embodiments, which may be combined with other embodiments, a protective barrier is provided. FIG. 4C may represent either precursors for a protective barrier or a molten form of a protective barrier being introduced into a portion of the unit pouch containing the rigid PCB portion of the positioning unit. One may note that the configuration of the protective barrier and the sensor unit of FIG. 4C is similar to that shown in FIGS. 3E-F, including the benefits to volume and weight minimization.

In instances where precursors to a protective barrier are introduced, the precursors may react, cure, and cause the resultant protective barrier material to connect to the surface of the sensor unit, preventing the formation of any gaps or channels in between the protective barrier and the sensor unit. In one or more embodiments, which may be combined with other embodiments, thermosetting polymer precursors is introduced for curing within the sensor pouch. Similarly, such bonding may occur between the protective barrier and the interior surface of the unit pouch. Such coupling between the material of the unit pouch, the protective barrier, and at least a portion of the sensor unit further affixes the sensor unit within the unit pouch. In one or more embodiments, which may be combined with other embodiments, molten thermoplastic polymer is introduced for setting within the sensor pouch. In instances where the protective barrier cools and solidifies from a molten state, a thermal shrink adhesion may occur between either or both the protective barrier and the positioning unit and the protective barrier and the material of the unit pouch.

In either case of a reactive curing or thermal setting introduced protective barrier material, the resultant protective barrier material may laminate any filament stitching bounding the portion of the unit pouch into which the protective barrier material is introduced. This lamination may the protective barrier material by provide additional resistance to fluid and dirt intake, seal any gaps or breaches in the unit pouch, and strengthen the overall sensor tag configuration.

FIG. 4D shows a schematic drawings visualizing an embodiment positioning tag. The positioning tag of FIG. 4D is similar to position tag 10 of FIGS. 1A-B. A midstich and a stich along the upper edge have been added to the embodiment sensor tab to further seen and isolate sections of the sensor tag. There is no optional eyelet or grommet; however, an optional hole appears provided in the attachment flap. The positioning tag of FIG. 4D appears configured and ready for application to an object where active or passive position information is desired.

In one or more embodiments, some of which may be combined with other embodiments, a method of use of a sensor tag may include coupling the sensor tag to an animal. The sensor tag may be coupled to the ear of an animal. The sensor tag may be coupled to the neck of an animal, such as through a lanyard. In some such instances, the sensor tag is configured with a sensor that detects geo-location. In some such instances, the sensor tag may be configured with an antenna configured to transmit a signal comprising data associated with the detected geo-location of the sensor tag. In some such instances, the sensor tag may be configured to locally save data associated with a detected geo-location of the sensor tag, such as to a memory chip or a hard drive.

In one or more embodiments, some of which may be combined with other embodiments, a method of use of the sensor tag may include detecting that a detrimental event to an animal has occurred during a period. A “detrimental event” may be one of several things, such as an animal has taken ill, or been attacked, or became inflicted with an infestation, or has been injured.

The period may be determined as a time between the when the animal was last inspected, such as being in or leaving a barn, and the time when the animal was inspected and determined to have been impacted, such as taking ill, been attacked, become inflicted or infested, or been injured. Such a determination may be made manually, such as through a visual inspection of the animal, automatically, such as through a sensor detecting an anomaly in a condition of the animal, or both. For example, a computer program may be utilized with the geo-located data and be programmed to recognize certain unusual animal movements or behavior, such as to recognize running in an evasive pattern, making attacking motions (as if being chased), or moving slowly or not at all (as if sick, hurt, or dead). In another example, a second sensor may be associated with temperature determination, and that sensor may indicate that the temperature of the animal is outside of a normal range.

In one or more embodiments, some of which may be combined with other embodiments, the method may include obtaining detected geo-location data for the period for an animal from the associated sensor tag using a signal connection. In one or more embodiments, some of which may be combined with other embodiments, the geo-location data for the period for an animal is obtained from the associated sensor tag using a wired connection. In one or more embodiments, some of which may be combined with other embodiments, the geo-location data for the period for an animal is obtained from the associated sensor tag using a wireless connection. As previously described, sensor tag 10 may be utilized for either wired or wireless transfer of geo-location data.

In one or more embodiments, some of which may be combined with other embodiments, a method of use of the sensor tag includes determining the location of the animal impacted by the detrimental event where the detrimental event occurred using the detected geo-location data. In one or more embodiments, some of which may be combined with other embodiments, the determination occurs manually, such as through a visual analysis of the geo-located data for the period. A user may use raw data or a computer program to help list or visualize the geo-location information versus time to estimate where the detrimental event occurred. In one or more embodiments, some of which may be combined with other embodiments, the determination occurs semi-automatically. For example, a computer program may be configured that receives all of the geo-location information, correlates the geo-location data with time, receives information from the user regarding certain impacted animals (and therefore associated geo-location data), and may return an determination showing where a specific location (a point or an area) where the detrimental event occurred. As previously stated, in estimating the location of where a detrimental event occurred, in one or more embodiments, some of which may be combined with other embodiments, data from one or more sensor tags associated with one or more animals is utilized.

In one or more embodiments, some of which may be combined with other embodiments, the method may further comprise determining the location of the animal impacted by the detrimental event for a period between about the occurrence of the detrimental event and the detection of the detrimental event using the detected geo-location data. In regards to a detrimental event that is related to an illness, an infection, or an infestation, estimating where the animal traveled to after determining when and where the detrimental event is believed to have occurred may permit prevention of the detrimental event from occurring in those other areas, such as an infestation spreading to another area where the animal traveled. Such a determination along with other geo-located data may indicate that additional animals may need to be treated or quarantined to allow an illness to run its course but also prevent the illness from spreading amongst other uninfected or potentially infected animals.

In one or more embodiments, some of which may be combined with other embodiments, applying a mitigation to the determined location where the detrimental event occurred, where the mitigation is suitable to prevent future occurrence of the detrimental event. In one or more embodiments, some of which may be combined with other embodiments, where applying the mitigation to the determined location where the detrimental event occurred also includes applying the mitigation to the determined location where the animal impacted by the detrimental event for a period between about the occurrence of the detrimental event and the detection of the detrimental event.

Benefits to a method for using a sensor tag in such a method are several-fold. Using geo-located data correlated with a specific time period and associated with one or more specific impacted animals gives the user a sense of significant confidence that a location where the one or more animals may have taken ill, been attacked, became afflicted with an infestation, or has been injured is accurately determined. With such a determination, a smaller area of treatment may be utilized, such as a specific portion of a field, a shelter, a source of water or shade, or a portion of fence. A relatively smaller treatment area is significant to many ranches and farms are multiple-acres, including thousands of acres. Minimizing the area of mitigation should result in less time effecting repairs, changes, spraying, or otherwise modifying the location to mitigate future illness, attack, damage, infection, or injury. In the case of treatment with chemicals, some of which may be harmful to the environment, to the animals, or to humans, a smaller area of treatment prevent over-use of such chemicals on the land and avoids “overspray”, such as chemicals carrying off the property via the air and onto the property of another. The determination of an area of treatment may also include not only the suspected area of illness, attack, or injury, but also include areas where the animal was located afterwards. So, for example, in the case of a tick or other parasitic infestation, not only may a user wish to treat the area where it is determined that the affliction of infestation occurred but also any area where the infested animals went after the suspected location of infestation as those areas may also now be infested. Again, such a combined treatment area may only be a small portion of the overall property in which the animals have access. In the case of a water-borne contagion, the data may reveal that not only is the user's property impacted but possibly those up and downstream and that notice needs to be provided to others.

As may be appreciated by one of ordinary skill in the art, one or more other components of the sensor tag may be configured with configurations utilizing one, some, or all of the unit pouch, the protective barrier, and the sensor unit in the various forms described. As well, alternative configurations of the sensor tag are also contemplated and envisioned.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional) to achieve desirable results. In certain circumstances, multitasking or parallel processing (or a combination of multitasking and parallel processing) can be advantageous and performed as deemed appropriate.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperability coupled with a hardware processor configured to perform the computer-implemented method or the instructions stored on the non-transitory, computer-readable medium.

While the various steps in an embodiment method or process are presented and described sequentially, one of ordinary skill in the art will appreciate that some or all of the steps may be executed in different order, may be combined or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

Embodiments of the present disclosure may suitably “comprise”, “consist” or “consist essentially of” the limiting features disclosed, and may be practiced in the absence of a limiting feature not disclosed. As used here and in the appended claims, the words “comprise,” “has,” and “include” and all grammatical variations thereof are each intended to have an open, non-limiting meaning that does not exclude additional elements or steps.

“Optional” and “optionally” means that the subsequently described material, event, or circumstance may or may not be present or occur. The description includes instances where the material, event, or circumstance occurs and instances where it does not occur.

As used, the term “determining” encompasses a wide variety of actions. For example, “determining” may include calculating, computing, processing, deriving, investigating, looking up (for example, looking up in a table, a database or another data structure), and ascertaining. Also, “determining” may include receiving (for example, receiving information) and accessing (for example, accessing data in a memory). Also, “determining” may include resolving, selecting, choosing, and establishing.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f), for any limitations of any of the claims, except for those in which the claim expressly uses the words ‘means for’ together with an associated function.

The following claims are not intended to be limited to the embodiments provided but rather are to be accorded the full scope consistent with the language of the claims.

What is claimed is:

1. A sensor tag, comprising: a sensor unit located within a unit pouch and at least in part encapsulated by a protective barrier, the protective barrier comprising a polymeric material, and the sensor tag weighing a total of no more than about 34.5 grams.

2. The sensor tag of claim 1, wherein the sensor tag is a positioning tag and the sensor unit is a positioning unit.

3. The sensor tag of claim 1, wherein the sensor tag is a gas composition tag and the sensor unit is a gas composition unit.

4. The sensor tag of claim 1, where the sensor tag is an accelerometer tag and the sensor unit is an accelerometer unit.

5. The sensor tag of claim 1, where the sensor tag is an environmental tag and the sensor unit is an environmental unit.

6. A sensor tag, comprising:
a sensor unit located within a unit pouch and at least in part encapsulated by a protective barrier, the protective barrier comprising a polymeric material, and the sensor tag weighing a total of no more than about 34.5 grams;
a battery; and
an antenna.

7. The sensor tag of claim 6, wherein the antenna is configured for receiving a Global Positioning System (GPS) signal, a Global System for Mobile Communications (GMS), a General Packet Radio Service (GPRS) signal, or a wireless fidelity (Wi-Fi) signal.

8. The sensor tag of claim 6, wherein the polymeric material of the protective barrier is comprised of a thermoset polymer, a thermoplastic material, a carbon-based material, or a silicon-based material.

9. The sensor tag of claim 6, wherein the protective barrier is comprised of a hydrophobic polymer, an elastomer, or a foamed polymeric material.

10. The sensor tag of claim 6, wherein the protective barrier is comprised of two or more polymeric materials.

11. The sensor tag of claim 6, wherein the unit pouch comprises a material that is a woven fabric.

12. The sensor tag of claim 6, wherein the unit pouch comprises a material that is an interwoven fabric.

13. The sensor tag of claim 6, wherein the unit pouch comprises a material that is a non-woven fabric.

14. The sensor tag of claim 6, wherein the unit pouch comprises a material that is a plastic film, a laminate, or a hydrophobic polymer.

15. The sensor tag of claim 6, wherein the unit pouch comprises a material that is selected from the group consisting of a polyethylene (PE), a liquid crystalline polymer (LCP), an aromatic polyamide (an “aramid”), a nylon, a polymer-coated natural material, a polypropylene, a polyurethane, a polyester, a polyacrylic, a rayon, a fluorinated polyethylene, and combinations thereof.

16. The sensor tag of claim 15, wherein the polyethylene comprises ultra-high molecular weight PE (UHMWPE).

17. A method for using a sensor tag, comprising:
detecting that a detrimental event to an animal has occurred during a period, where a sensor tag configured with a geo-locating sensor for detecting geo-location and producing geo-location data is coupled to the animal;
obtaining the detected geo-location data for the period for the animal impacted by the detrimental event from the associated sensor tag using a signal connection; and
determining the location where the detrimental event occurred using the detected geo-location data.

18. The method of claim 17, further comprising coupling the sensor tag to the animal.

19. The method of claim 17, further comprising determining the location of the animal impacted by the detrimental event for a period between about the occurrence of the detrimental event and the detection of the detrimental event using the detected geo-location data.

20. The method of claim 17, further comprising applying a mitigation to the determined location where the detrimental event occurred, where the mitigation is suitable to prevent future occurrence of the detrimental event.
